(19) United States
(12) Patent Application Publication
(10) Pub. No.: US 2014/0179247 A1
(43) Pub. Date: Jun. 26, 2014

(54) APPARATUS AND METHOD FOR CONTROLLING TRANSMITTING POWER OF WIRELESS DEVICE

(71) Applicant: Electronics and Telecommunications Research Institute, Daejeon (KR)

(72) Inventors: Sang In CHO, Daejeon (KR); Kyu Min KANG, Daejeon (KR); Jae Cheol PARK, Gwangju-si (KR); Byung Jang JEONG, Daejeon (KR)

(73) Assignee: Electronics and Telecommunications Research Institute, Daejeon (KR)

(21) Appl. No.: 14/140,595

(22) Filed: Dec. 26, 2013

(30) Foreign Application Priority Data
Dec. 26, 2012 (KR) 10-2012-0153349

(51) Int. Cl. H04B 1/04

(52) U.S. Cl. CPC H04B 1/04
USPC 455/113

(57) ABSTRACT

Provided is an apparatus and method for controlling a transmission output of a radio device using a television (TV) band based on a frequency band, the apparatus including a frequency band selecting unit to select frequency bands to be compared, a radio wave attenuation calculation unit to calculate a radio wave attenuation for each of the selected frequency bands, and a transmission output control unit to automatically control the transmission output of the radio device using a TV band based on a difference value among the calculated attenuation values. According to an example embodiment, it is possible to extend a service area while sufficiently protecting a service being provided in the TV band, thereby realizing an efficient use of frequency resources.

### TECHNICAL FIELD

The present invention relates to an apparatus and method for controlling a transmission output of a radio device, and more particularly, to an apparatus and method for controlling a transmission output of a radio device using a television (TV) band.

### BACKGROUND ART

A radio device using a television (TV) band may be used in a protective separation distance from an existing service area, thereby preventing an occurrence of interference in a service, for example, a wireless microphone, a digital television (DTV) broadcasting, and the like present in the TV band. The protective separation distance may be calculated based on a radio wave arrival distance of a TV band radio device, and a separation distance satisfying a protection ratio of an existing service may be calculated to be applied to the protective separation distance.

When TV band radio equipment transmits a transmission signal at a predetermined transmission output, the separation distance satisfying the protection ratio may be measured to be greater at a low frequency when compared to a high frequency. Thus, the protective separation distance may be determined based on a relatively low frequency. When the protective separation distance is determined based on a relatively high frequency, an unnecessary length may be included in the separation distance.

Korean Patent Application No. 2010-0098229 discloses a conventional art for controlling a transmission output of a radio device. In this disclosure, a user may manually control a transmission output of a radio device by manually retrieving and selecting a mode, rather than being controlled automatically. Also, an issue of an unnecessary length of separation distance being included at a relatively high frequency is still unresolved.

### DISCLOSURE OF INVENTION

### Technical Goals

An aspect of the present invention provides a transmission output control apparatus and method for automatically controlling a transmission output of a radio device using a television (TV) band based on a frequency band, thereby solving the aforementioned issue.

However, the goals accomplished by the implementation of the present invention may not be limited thereto. Instead, other purposes of the present invention may be clearly understood by those of ordinary skill in the art from the following descriptions.

### Technical Solutions

According to an aspect of the present invention, there is provided an apparatus for controlling a transmission output of a radio device, the apparatus including a frequency band selecting unit to select frequency bands to be compared, a radio wave attenuation calculation unit to calculate a radio wave attenuation for each of the selected frequency bands, and a transmission output control unit to automatically control the transmission output of the radio device using a television (TV) band based on a difference value among the calculated attenuation values.

The frequency band selecting unit may select, from a TV white space, the frequency bands to be compared.

The frequency band selecting unit may select one of the frequency bands to be compared, to be a reference frequency band, and select the reference frequency band from a very high frequency (VHF) band or an ultra high frequency (UHF) band.

The frequency band selecting unit may use a VHF band in a frequency range between 54 megahertz (MHz) and 300 MHz to be the VHF band, and use a UHF band in a frequency range between 300 MHz and 698 MHz to be the UHF band.

When the frequency band selecting unit selects the reference frequency band from the VHF band, the frequency band selecting unit may select the lowest frequency band of the VHF band to be the reference frequency band, and when the frequency band selecting unit selects the reference frequency band from the UHF band, the frequency band selecting unit may select the highest frequency band of the UHF band to be the reference band.

The radio wave attenuation calculation unit may calculate a radio wave attenuation in a free space as the radio wave attenuation.

According to another aspect of the present invention, there is also provided a method of controlling a transmission output of a radio device, the method including selecting frequency bands to be compared, calculating a radio wave attenuation for each of the selected frequency bands, and automatically controlling the transmission output of the radio device using a TV band based on a difference value among the calculated radio wave attenuations.

The selecting may include selecting the frequency bands to be compared, from a TV white space.

The selecting may include selecting one of the frequency bands to be compared, to be a reference frequency band, and selecting the reference frequency band from a VHF band or a UHF band.

The selecting may include using a VHF band in a frequency range between 54 MHz and 300 MHz as the VHF band, and using a UHF band in a frequency range between 300 MHz and 698 MHz as the UHF band.

The selecting may include selecting, when the reference frequency band is selected from the VHF band, the lowest frequency band of the VHF band as the reference frequency band and selecting, when the reference frequency band is selected from the UHF band, the highest frequency band of the UHF band as the reference band.

The calculating may include calculating a radio wave attenuation in a free space as the radio wave attenuation.

### Advantageous Effects

According to an aspect of the present invention, it is possible to extend a service area by automatically controlling a transmission output in consideration of a radio wave attenuation based on a frequency, in a process of transmitting a transmission signal by a radio device using a television (TV) band, while sufficiently protecting a service being provided in the TV band. Through this, efficient usage of frequency resources may be realized, and an unnecessary length of a protective separation distance caused when the radio device using the TV band uses a high frequency may be avoided.

### BRIEF DESCRIPTION OF DRAWINGS

FIG. 1 is a block diagram illustrating an apparatus for controlling a transmission output of a radio device according to an exemplary embodiment.

FIG. 2 is a flowchart illustrating a method of controlling a transmission output of a radio device according to an exemplary embodiment.

FIG. 3 is a diagram illustrating the method of controlling a transmission output of a radio device of FIG. 2.

### BEST MODE FOR CARRYING OUT THE INVENTION

Hereinafter, embodiments of the present invention will be described in detail with reference to the attached drawings. Reference now should be made to the drawings, in which the same reference numerals are used throughout the different drawings to designate the same or similar components. When it is determined detailed description related to a known function or configuration they may render the purpose of the present invention unnecessarily ambiguous in describing the present invention, the detailed description will be omitted here. While the present invention is described with reference to exemplary embodiments thereof, various changes and modifications can be made by those skilled in the art without departing from the essential features of the present invention. Therefore, the embodiments disclosed in the present invention are not intended to limit the technical spirit of the present invention.

A television white space (TVWS) may refer to a band not used locally in a television (TV) broadcasting band. Due to an advantageous property of a radio wave of the TVWS ensuring service coverage greater than that of a frequency of at least 1 gigahertz (GHz), the TVWS may provide various services for use in a field of public safety, region information provision, a super wireless fidelity (Wi-Fi), and the like. Accordingly, to realize efficient usage of limited frequency resources and offer various advanced services, it is expected that a number of TV band radio devices using the TVWS may appear with great frequency.

In general, a very high frequency (VHF) band or an ultra high frequency (UHF) band may be used for TV band radio equipment, and a frequency range may include a band between 54 megahertz (MHz) and 698 MHz. In an exemplary embodiment, an apparatus and method for automatically controlling a transmission output based on a frequency band may be provided to realize an efficient communication for a TV band radio device using the VHF band or the UHF band.

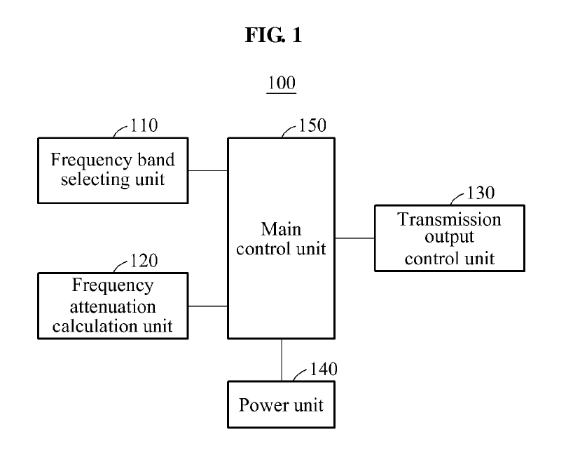

FIG. 1 is a block diagram illustrating an apparatus for controlling a transmission output of a radio device according to an exemplary embodiment. Hereinafter, the apparatus for controlling a transmission output may be also referred to as a transmission output control apparatus. Referring to FIG. 1, a transmission output control apparatus 100 may be mounted on a radio device to control a transmission output, and include a frequency band selecting unit 110, a frequency attenuation calculation unit 120, a transmission output control unit 130, a power unit 140, and a main control unit 150.

The frequency band selecting unit 110 may provide a function of selecting frequency bands to be compared.

The frequency band selecting unit 110 may select the frequency bands to be compared from a TV idle band. Here, the TV idle band may indicate a TV white space.

The frequency band selecting unit 110 may select one of the frequency bands to be compared, to be a reference frequency band. In this instance, the frequency band selecting unit may select the reference frequency band from a VHF band or a UHF band. In general, the VHF band may have a frequency range between 30 MHz and 300 MHz, and the UHF band may have a frequency range between 300 MHz and 3 GHz. In an exemplary embodiment, the frequency band selecting unit 110 may use a VHF band in a frequency range between 54 MHz and 300 MHz, and a UHF band in a frequency range between 300 MHz and 698 MHz based on the TVWS.

The frequency band selecting unit 110 may select the lowest frequency band of the VHF band to be the reference frequency band when selecting the reference frequency band from the VHF band, and select the highest frequency band of the UHF band to be the reference band when selecting the reference frequency band from the UHF band. In an exemplary embodiment, since a VHF band between 54 MHz and 300 MHz is used to be the VHF band, a VHF band of 54 MHz may be selected to be the reference frequency band. Also, since the UHF band between 300 MHz and 698 MHz is used to be the UHF band, a UHF band of 698 MHz may be selected to be the reference band.

The radio wave attenuation calculation unit 120 may provide a function of calculating a radio wave attenuation for each frequency band selected by the frequency band selecting unit 110. The radio wave attenuation calculation unit 120 may calculate a radio wave attenuation in a free space.

The transmission output control unit 130 may provide a function of automatically controlling a transmission output of a radio device using a TV band based on a difference value among the radio wave attenuations calculated by the radio attenuation calculation unit 120.

The power unit 140 may provide a function of supplying power to each portion included in the transmission output control apparatus 100. However, since the transmission output control apparatus 100 is generally mounted on a radio device, the power unit 140 may be included as a necessity.

The main control unit 150 may provide a function of controlling an overall operation of each portion included in the transmission output control apparatus.

Hereinafter, descriptions about a method of controlling a transmission output, implemented by the transmission output control apparatus will be provided. The method of controlling a transmission output may also be referred to as a transmission output control method.

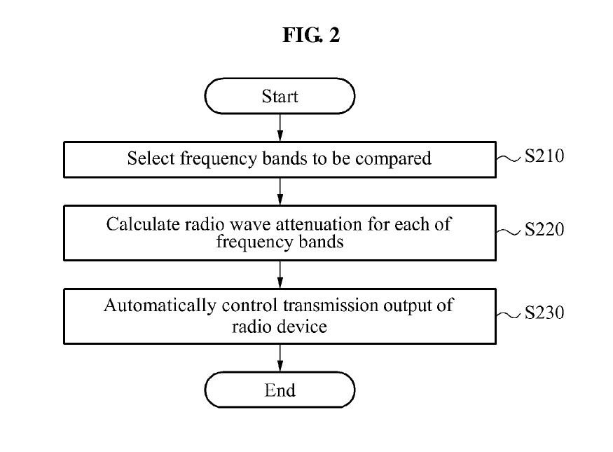

FIG. 2 is a flowchart illustrating a method of controlling a transmission output of a radio device according to an exemplary embodiment. Following descriptions will be provided with reference to FIG. 1 and FIG. 2.

In operation S210, the frequency band selecting unit 110 may select frequency bands to be compared.

The frequency band selecting unit 110 may select the frequency bands to be compared from a TVWS in operation S210.

In addition, the frequency band selecting unit 110 may select one of the frequency bands to be compared, to be a reference frequency band in operation S210, and the reference frequency band may be selected from a VHF band or a UHF band. In this instance, the frequency band selecting unit 110 may use a VHF band between 54 MHz and 300 MHz to be the VHF band, and use a UHF band between 300 MHz and 698 MHz to be the UHF band.

In operation S210, the frequency band selecting unit 110 may select the lowest frequency band of the VHF band to be the reference frequency band when selecting the reference frequency band from the VHF band, and select the highest frequency band of the UHF band to be the reference band when selecting the reference frequency band from the UHF band.

In operation S220, the radio wave attenuation calculation unit 120 may calculate a radio wave attenuation for each of the selected frequency bands when operation S210 ends. The radio wave attenuation calculation unit 120 may calculate a radio wave in a free space to be the radio wave attenuation.

In operation 230, the transmission output control unit may automatically control a transmission output of a radio device using a TV band based on a difference value among the calculated radio wave attenuations when operation S230 ends.

A TV band radio device using a TVWS may use a VHF band or a UHF band. Communication by a TV band radio device operating in the VHF band may be possible in a wide range based on an identical output when compared to a TV band radio device operating in the UHF band. The TV band radio device may be used in a predetermined protective separation distance to protect a service present in a TV band. The protective separation distance may be calculated based on a frequency of 54 MHz being used, and a maximum distance by which a radio wave may arrive. Through this, the service present in the TV band may not experience interference when a frequency between 54 MHz and 698 MHz. However, when a frequency greater than a reference frequency is used, a radio wave attenuation may be increased in a free space and thus, a size of a service area may be reduced. Accordingly, in an exemplary embodiment, there is provided a method for realizing an efficient use of a frequency by allowing an operation to be performed in a service area identical to that of the reference frequency despite use of a frequency higher than the reference frequency when the protective separation distance is calculated based on the lowest frequency to prevent an occurrence of interference from the service present in the TV band.

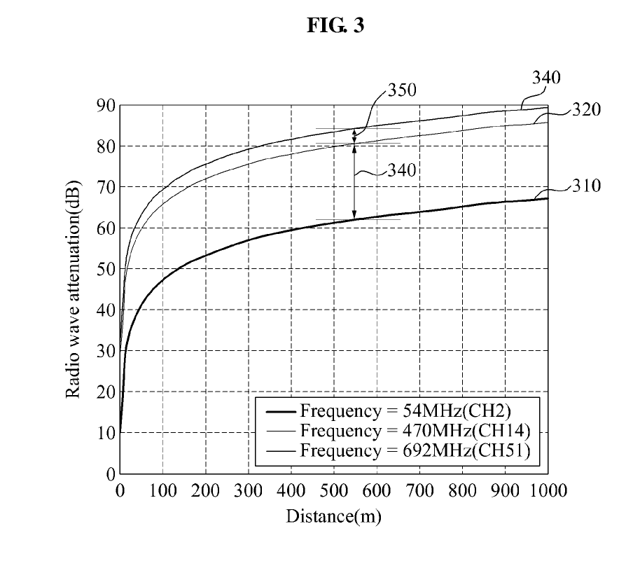

Hereinafter, descriptions about an exemplary embodiment of the present invention will be provided with reference to FIG. 3.

FIG. 3 is a diagram illustrating the transmission output control method of FIG. 2.

Referring to FIG. 3, a free space radio wave attenuation of a band between 54 MHz and 698 MHz may be indicated. A free space radio wave attenuation 310 of a frequency of 54 MHz indicating a starting frequency of a VHF band may be approximately 67 decibels (dB) at a distance of 1 kilometer (km). A free space radio wave attenuation 320 of a frequency of 470 MHz indicating a starting frequency of a UHF band may be approximately 89 dB at the distance of 1 km. A free space radio wave attenuation 330 of a UHF band of 698 MHz may be approximately 89 dB.

A difference 340 in the free space radio wave attenuation between 54 MHz band and 470 MHz band may be approximately 19 dB, and a difference 350 in the free space radio wave attenuation between 470 MHz band and 698 MHz band may be approximately 3 dB. Thus, a difference in the free space radio wave attenuation between 54 MHz band and 698 MHz band may be approximately 22 dB.

When a TV band radio device operating in a frequency band between 54 MHz and 698 MHz transmits an identical transmission output at all frequencies, a service available area may vary based on a frequency to be used. In an exemplary embodiment, the TV band radio device may automatically control the transmission output by compensating for a difference in the free space radio wave attenuation so as to operate in an identical service available area in all available frequencies and then, transmit the controlled transmission output. Accordingly, when a transmission is performed using a frequency of 470 MHz, 19 dB of the transmission output may be added when compared to a transmission performed using a frequency of 54 MHz, and when a transmission is performed using a frequency of 698 MHz, 3 dB of the transmission output may be added as compared to a transmission performed using a frequency of 470 MHz.

In the above description, although all components constituting the embodiments of the present invention have been described as being combined into a single body or as being combined into and operated as a single body, the present invention is not necessarily limited by these embodiments. That is, one or more of all the components may be selectively combined and operated within the scope of the object of the present invention. Further, all the components may be individually implemented as independent hardware devices, but some or all of the components may also be selectively combined and implemented in the form of a computer program having program modules which perform some or all of the functions combined by one or more hardware devices. Such a computer program is stored in computer readable storage media, such as universal serial bus (USB) flash drive, flash memory, and CD ROM discs, and is read and executed by the computer, so that the embodiments of the present invention may be implemented. Examples of the storage media for storing the computer program may include magnetic recording media, optical recording media, carrier wave media, etc.

Unless otherwise defined, all terms including technical and scientific terms, used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### DESCRIPTION OF THE REFERENCE NUMERALS

100: Transmission output control apparatus
110: Frequency band selecting unit
120: Radio wave attenuation calculation unit
130: Transmission output control unit
140: Power unit
150: Main control unit

1. An apparatus for controlling a transmission output of a radio device, the apparatus comprising:
a frequency band selecting unit to select frequency bands to be compared;
a radio wave attenuation calculation unit to calculate a radio wave attenuation for each of the selected frequency bands; and
a transmission output control unit to automatically control the transmission output of the radio device using a television (TV) band based on a difference value among the calculated attenuation values.

2. The apparatus of claim 1, wherein the frequency band selecting unit selects, from a TV white space, the frequency bands to be compared.

3. The apparatus of claim 2, wherein the frequency band selecting unit selects one of the frequency bands to be compared, to be a reference frequency band, and selects the reference frequency band from a very high frequency (VHF) band or an ultra high frequency (UHF) band.

4. The apparatus of claim 3, wherein the frequency band selecting unit uses a VHF band in a frequency range between 54 megahertz (MHz) and 300 MHz to be the VHF band, and uses a UHF band in a frequency range between 300 MHz and 698 MHz to be the UHF band.

5. The apparatus of claim 3, wherein when the frequency band selecting unit selects the reference frequency band from the VHF band, the frequency band selecting unit selects the lowest frequency band of the VHF band to be the reference frequency band, and when the frequency band selecting unit selects the reference frequency band from the UHF band, the frequency band selecting unit selects the highest frequency band of the UHF band to be the reference band.

6. The apparatus of claim 1, wherein the radio wave attenuation calculation unit calculates a radio wave attenuation in a free space as the radio wave attenuation.

7. A method of controlling a transmission output of a radio device, the method comprising:
selecting frequency bands to be compared;
calculating a radio wave attenuation for each of the selected frequency bands; and
automatically controlling the transmission output of the radio device using a television (TV) band based on a difference value among the calculated radio wave attenuations.

8. The method of claim 7, wherein the selecting comprises selecting the frequency bands to be compared, from a TV white space.

9. The method of claim 8, wherein the selecting comprises selecting one of the frequency bands to be compared, to be a reference frequency band, and selecting the reference frequency band from a very high frequency (VHF) band or an ultra high frequency (UHF) band.

10. The method of claim 9, wherein the selecting comprises using a VHF band in a frequency range between 54 megahertz (MHz) and 300 MHz as the VHF band, and using a UHF band in a frequency range between 300 MHz and 698 MHz as the UHF band.

11. The method of claim 9, wherein the selecting comprises selecting, when the reference frequency band is selected from the VHF band, the lowest frequency band of the VHF band as the reference frequency band and selecting, when the reference frequency band is selected from the UHF band, the highest frequency band of the UHF band as the reference band.
